(19) United States
(12) Patent Application Publication
(10) Pub. No.: US 2012/0154685 A1
(43) Pub. Date: Jun. 21, 2012

(54) Video Display Apparatus, Video Display Method and Computer Readable Storage Medium

(76) Inventors: Sachie Yokoyama, Ome-shi (JP); Mieko Onodera, Kawasaki-shi (JP); Naoki Esaka, Tachikawa-shi (JP)

(21) Appl. No.: 13/241,028

(22) Filed: Sep. 22, 2011

(30) Foreign Application Priority Data
Dec. 20, 2010 (JP) 2010-283207

(51) Int. Cl. H04N 5/268

(52) U.S. Cl. 348/706; 348/E05.057

(57) ABSTRACT

According to one embodiment, a video display apparatus includes a display screen generator, a waiting time determination module, and a display. The display screen generator generates a first screen and a second screen from predetermined information. The waiting time determination module determines an estimated waiting time. The display compares the estimated waiting time with a reference time, displays the first screen when the estimated waiting time is shorter than the reference time, and displays the second screen when the estimated waiting time is longer than the reference time.

### CROSS-REFERENCE TO RELATED APPLICATIONS

This application is based upon and claims the benefit of priority from prior Japanese Patent Application No. 2010-283207, filed Dec. 20, 2010, the entire contents of which are incorporated herein by reference.

### FIELD

Embodiments described herein relate generally to a video display apparatus, a video display method, and a computer readable storage medium that display content information when the screen is switched.

### BACKGROUND

In recent years, TV sets mounted with a Web browser have been developed. In this type of TV sets, Web site information can be browsed by a remote controller operation while a TV broadcast program is viewed. To view Web site information on the TV set, time and efforts is needed such as inputting an URL by using a remote controller. To reduce such time and efforts, a method of allocating access to a bookmarked specific Web site by using a bookmark function to a channel number to simplify access to a specific Web site has been proposed.

On the other hand, with greater functionality of TV sets, a waiting time for various operations of a TV set arises when the TV set is turned on, the display screen changes from a broadcast program to Web site information, or TV settings are reflected. In the past, an approach such as displaying a message indicating information processing or displaying a portion of content displayed after the processing is completed or specific content information during the waiting time has been adopted.

In a conventional video display apparatus, a waiting time may arise due to an operation accompanied by switching of the screen display. However, even if a message indicating information processing is displayed in the screen during a waiting time, the user knows only an occurrence of a waiting time and there is almost no merit for the user. If a portion of content displayed after the processing is completed or specific content information is displayed, the user recognizes content in a short time if the display content is simple with regards to the waiting time and then simply waits. Conversely, if the display content is too complex, it is difficult for the user to recognize the content during the waiting time. That is, there is an issue of display content being too simple or too complex depending on the waiting time and even if a portion of content displayed after the processing is completed or specific content information is displayed, such an approach may not be effective.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating an overall configuration of a TV set according to a first embodiment.

FIG. 2 is an exemplary block diagram illustrating the configuration of a Web information display screen generator in the TV set in FIG. 1.

FIG. 3 is an exemplary flowchart illustrating an operation of screen selection in the first embodiment.

FIGS. 4A and 4B are exemplary schematic diagrams exemplifying display screens in the first embodiment.

FIG. 5 is an exemplary diagram illustrating storage information in the Web information display screen generator of a second embodiment.

FIGS. 6A and 6B are schematic diagrams exemplifying the display screen of the second embodiment.

FIG. 7 is an exemplary diagram illustrating the storage information in the Web information display screen generator of a third embodiment.

FIG. 8 is an exemplary flowchart illustrating the operation of the screen selection of the third embodiment.

### DETAILED DESCRIPTION

Various embodiments will be described hereinafter with reference to the accompanying drawings.

In general, according to one embodiment, a video display apparatus includes a display screen generator, a waiting time determination module, and a display. The display screen generator generates a first screen and a second screen from predetermined information. The waiting time determination module determines an estimated waiting time. The display compares the estimated waiting time with a reference time, displays the first screen when the estimated waiting time is shorter than the reference time, and displays the second screen when the estimated waiting time is longer than the reference time.

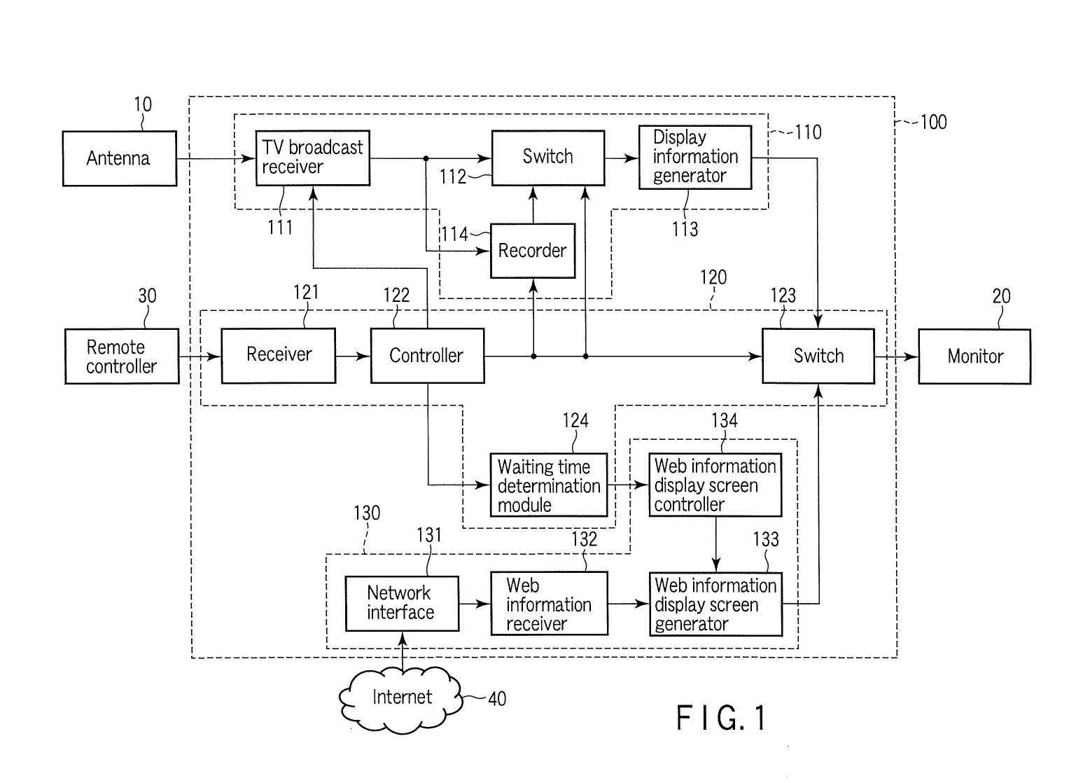

FIG. 1 is a block diagram illustrating an overall configuration of a TV set according to the first embodiment.

An antenna 10 and a monitor 20 are connected to a TV set body 100, which can further receive a signal of a remote controller 30 and connect to an Internet 40.

The TV set body 100 includes a TV signal processor 110, a switching unit 120, and a Web signal processor 130. The TV signal processor 110 includes a TV broadcast receiver 111, a switch 112, a display information generator 113, and a recorder 114. The switching unit 120 includes a receiver 121, a controller 122, a switch 123, and a waiting time determination module 124. The Web signal processor 130 includes a network interface 131, a Web information receiver 132, a Web information display screen generator 133, and a Web information display screen controller 134.

The TV broadcast receiver 111 includes a TV tuner and receives a TV broadcast program corresponding to the channel set by the controller 122. The recorder 114 includes a hard disk or semiconductor memory and records the TV broadcast program received by the TV broadcast receiver 111 under instructions from the controller 122. The switch 112 switches a signal from the TV broadcast receiver 111 and a signal from the recorder 114 under instructions from the controller 122. The display information generator 113 generates a TV signal that can be displayed in the monitor 20 from a signal obtained via the switch 112.

The receiver 121 receives an operation signal from the TV remote controller 30. The TV remote controller 30 is used to input various commands specifying operations of the TV set and thus, receiving a remote controller operation signal corresponds to detection of presence/absence of a command. As a unit to detect presence/absence of a command, the receiver 121 may also detect an operation of a switch provided in the TV set body.

The controller 122 issues control instructions to each module/unit in accordance with commands from the remote controller 30. For example, the controller 122 sends channel information to be received to the TV broadcast receiver 111, sends recording instruction information to the recorder 114, sends switching information to the switch 123, and sends a remote controller operation signal to the waiting time determination module 124. The switch 123 switches a TV signal from the display information generator 113 and a Web screen signal from the Web information display screen generator 133 under instructions from the controller 122 to output one of these signals to the monitor 20. The waiting time determination module 124 determines an estimated time (hereinafter, referred to as a waiting time) tw until processing is completed when a TV operation is specified under instructions from the controller 122.

In the present embodiment, the waiting time determination module 124 does not operate for all TV operations and operates only for operations predicted to cause a waiting time equal to a certain time or more. This is because a predetermined screen is displayed during the waiting time from the start to the end, but if the waiting time is short, the display of the screen is omitted. An example of the operation predicted to cause a waiting time equal to a certain time or more from the start to the end is a screen change operation from the TV signal screen to the Web screen. However, the waiting time determination module 124 may operate for all TV operations. The waiting time determination module 124 may create a table of relationship between the TV operation and the waiting time tw so that the waiting time tw corresponding to the operation is determined by referring to the table.

The network interface 131 is connected to the Internet 40 by a LAN or wireless LAN. The Web information receiver 132 receives Web site information of the address specified by the user. The Web information display screen generator 133 generates a display screen of a Web site received by the Web information receiver 132 and also generates a screen to be displayed on the monitor 20 when the waiting time is short and a screen to be displayed when the waiting time is long for each of the Web sites by periodically accessing Web sites registered in advance.

The Web information display screen controller 134 selects the short waiting time screen or the long waiting time screen for the Web site in accordance with the waiting time tw determined by the waiting time determination module 124 and outputs the selected screen to the switch 123.

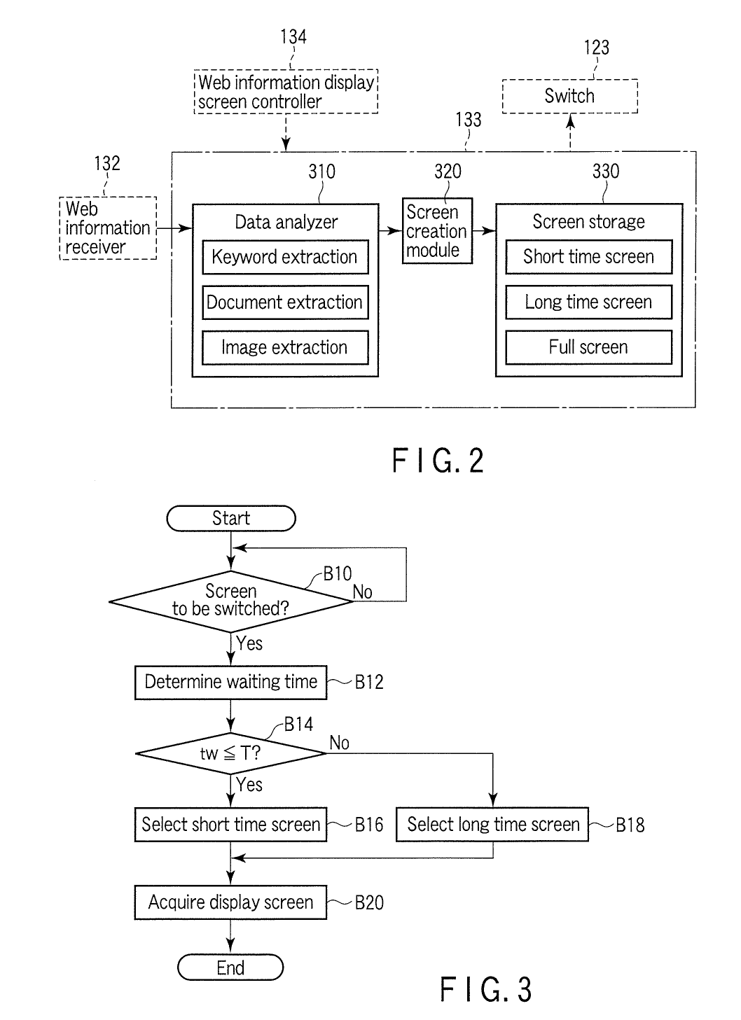

As illustrated in FIG. 2, the Web information display screen generator 133 includes a data analyzer 310 that analyzes data of each of the registered Web sites received by the Web information receiver 132, a screen creation module 320 that creates a screen based on analysis results, and a screen storage 330 that stores the created screen for each of the Web sites.

The data analyzer 310 extracts a keyword, document, and video from HTML files of a Web site. For example, the title is extracted as a keyword. If, for example, there is a plurality of videos, the representative video is selected as the video. The video includes not only a still image such as a JPEG file specified by the IMG element of an HTML file, but also a dynamic image such as a Flash file embedded in a specific DIV element. For example, a summary, which is a portion of text data, is extracted as the content document.

The screen creation module 320 creates a short waiting time screen (first screen information) from the extracted keyword and video and creates a long waiting time screen (second screen information) from the extracted keyword, video, and document. These screens are stored in the screen storage 330. The above waiting time screens are created at regular intervals and the screen is updated at regular intervals when the Web sites are periodically accessed by the Web information display screen generator 133. The screen storage 330 stores these waiting time screens separately and selects one of the screens under instructions from the Web information display screen controller 134 and outputs the selected screen to the switch 123.

In addition to the waiting time screens, the screen creation module 320 can also create a full screen of a Web site and the created full screen is stored in the screen storage 330. These screens are used for Web site browsing.

When TV broadcast program is received, the TV broadcast receiver 111 receives a broadcast program of the specified channel, the switch 112 selects the TV broadcast receiver 111, and the display information generator 113 generates a TV signal. The switch 123 is switched to the TV side to cause the monitor 20 to display TV information. When a broadcast program recorded in the recorder 114 is viewed, the monitor 20 is caused to display recorded TV information by the recorder 114 being selected by switch unit 112 and a TV signal being generated by the display information generator 113.

On the other hand, the Web information receiver 132 has addresses of Web sites registered in advance and acquires Web information by periodically accessing the registered addresses. The Web information display screen generator 133 creates and stores a short waiting time screen and a long waiting time screen from each of the received Web site information. Each screen is created from the latest Web site information accessed by the Web information receiver 132 and thus is periodically updated.

If a switching operation of the screen to be displayed on the monitor 20 is performed by the remote controller 30 (YES in Block B10), for example, switched from TV viewing to Web browsing, as illustrated in the flowchart in FIG. 3, the waiting time determination module 124 determines the waiting time tw necessary to switch the screen to one of the registered Web site (Block B12). The waiting time tw depends on the Web site.

Subsequently, the determined waiting time tw and a preset reference time T are compared (Block B14). If tw≦T, the Web information display screen controller 134 makes an inquiry about the short waiting time screen at the Web information display screen generator 133 (Block B16). If tw>T, the Web information display screen controller 134 makes an inquiry about the long waiting time screen at the Web information display screen generator 133 (Block B18). The Web information display screen generator 133 selects the screen in accordance with the inquiry and the waiting time screen is displayed in the monitor 20 by the Web side being selected by the switch 123 (Block B20).

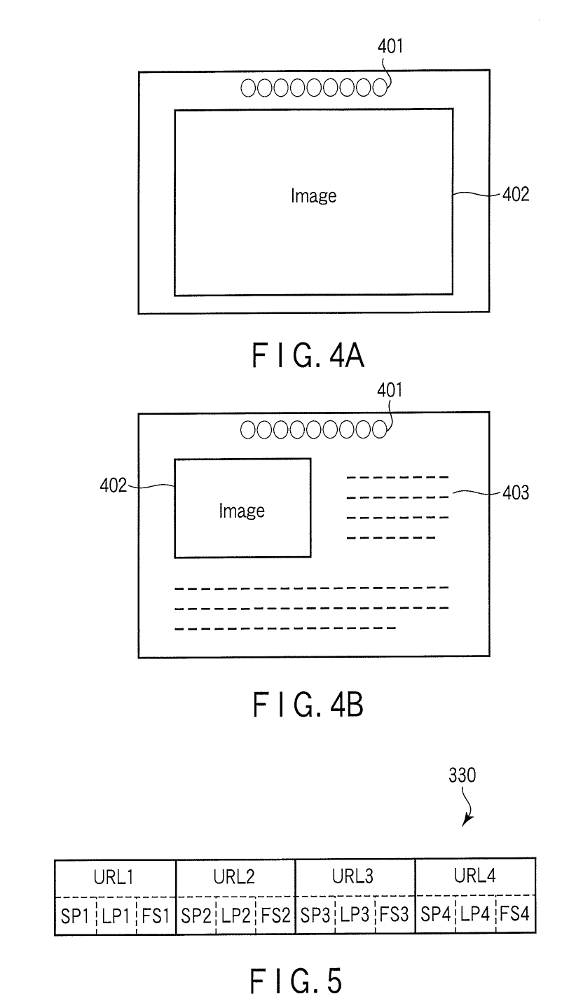

FIGS. 4A and 4B exemplify the waiting time screen. FIG. 4A illustrates a short waiting time screen including a title 401 and an image (video) 402 that are information from the same Web site. FIG. 4B illustrates a long waiting time screen including, in addition to the title 401 and the image 402 that are information from the same Web site, a document 403. In FIG. 4A, the image 402 is displayed over almost an entire screen to make effective use of the display area, but in FIG. 4B, the image 402 is displayed in a smaller area to secure an area for the document 403.

In this manner, the monitor 20 can be caused to display a portion of the registered Web site accessed in advance until processing of a TV operation called the screen switching from the TV reception screen to the Web information display screen is completed. Moreover, the user can view useful information during the waiting time by changing display content in accordance with the length of the waiting time. More specifically, if the waiting time is short, necessary information can instantaneously be comprehended by the title and image alone and if the waiting time is long, detailed information can be comprehended by reading a document, in addition to the observation of the title and image.

When the switching operation of the screen is completed, the homepage of the Web site is displayed in the monitor 20 by a full screen of the Web stored in the Web information display screen generator 133 being selected by the Web information display screen controller 134.

According to the present embodiment, as described above, when some TV operation is instructed to view the registered Web site, the monitor 20 can be caused to display the waiting time screen having a pre-accessed content depending on the length of the waiting time during the waiting time from the start to the end of processing accompanying the operation. Therefore, the monitor 20 can be caused to display optimum content in accordance with the length of the waiting time when the display screen is switched to the registered Web site screen, so that useful information can be provided to the user in the waiting time when the screen display is switched.

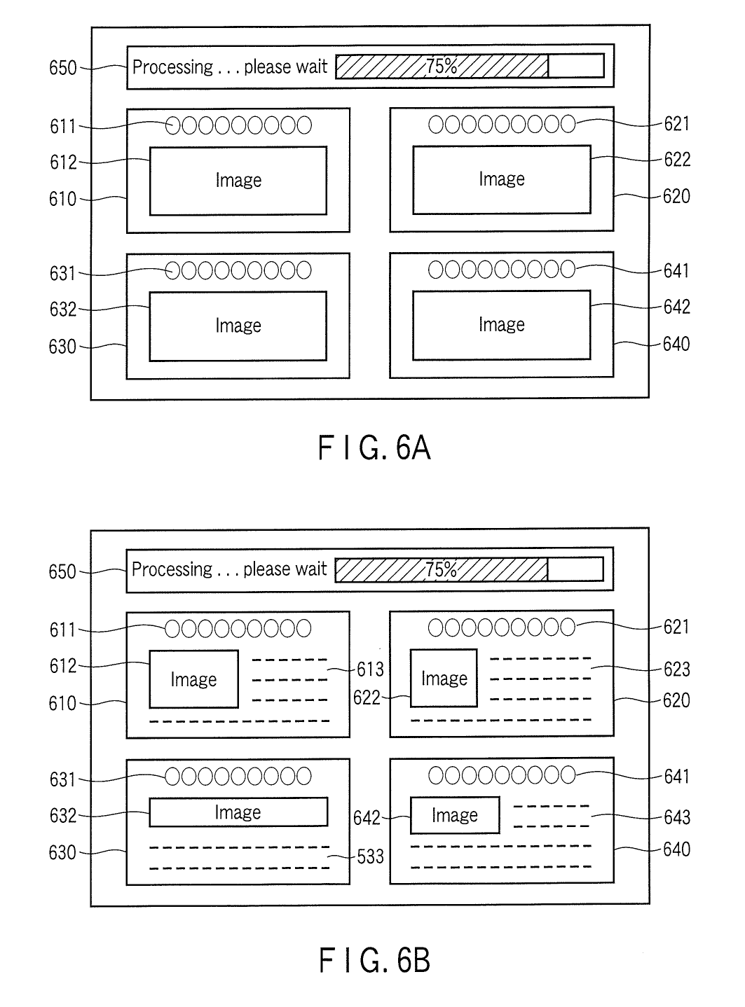

FIGS. 5 and 6 show a second embodiment. FIG. 5 is a diagram illustrating storage information in the screen storage 330 of the Web information display screen generator 133, and FIGS. 6A and 6B are schematic diagrams exemplifying the display screen.

The apparatus of the second embodiment is similar to that in the first embodiment described above and also the basic operation is similar to that in the first embodiment. The second embodiment is different from the first embodiment in that information of a plurality of registered Web site information is displayed, instead of information of one Web site to be accessed as a waiting time screen.

The screen storage 330 of the Web information display screen generator 133 has, as shown in FIG. 5, short waiting time screens SP (SP1 to SP4) and long waiting time screens LP-(LP1 to LP4) for a plurality of registered Web sites (for example, four sites) stored therein. For example, a URL 1 is information from a news related Web site, a URL 2 is information from a Web site of weather forecast, a URL 3 is information from a sports related Web site, and a URL 4 is information from a TV related Web site. The Web information display screen generator 133 can access the above four Web sites. The screen storage 330 also stores full screens FS1, FS2, FS3, and FS4 of Web sites themselves.

In the present embodiment, when switched from TV viewing to Web browsing of one of the four Web sites, the waiting time tw for the one of the four Web sites is determined like in the first embodiment described above. If tw≦T, the short waiting time screen is selected and if tw>T, the long waiting time screen is selected.

FIGS. 6A and 6B illustrate examples that integrate and display information from the four Web sites. FIG. 6A illustrates a short waiting time screen and FIG. 6B illustrates a long waiting time screen. The display screen in the present embodiment includes an area 650 showing the progress of processing and, for example, four areas 610, 620, 630, 640 illustrating Web information. The Web areas 610, 620, 630, 640 include titles 611, 621, 631, 641, images (videos) 612, 622, 632, 642, and/or documents 613, 623, 633, 643.

Information of registered Web sites is displayed in the Web areas 610 to 640. For example, the Web area 610 shows information from a Web site corresponding to URL 1 and related to news, the Web area 620 shows information from a Web site corresponding to URL 2 and related to weather forecast, the Web area 630 shows information from a Web site corresponding to URL 3 and related to sports, and the Web area 640 shows information from a Web site corresponding to URL 4 and related to TV.

Thus, in the present embodiment, a plurality of items of information can be browsed at a time during the waiting time of a remote controller operation. Therefore, the same effect as in the first embodiment can naturally be obtained and also a lot of information can be provided to the user.

The number of Web sites displayed during the waiting time is not limited to four and can be changed appropriately by user settings. Preset addresses of Web sites can also be changed appropriately.

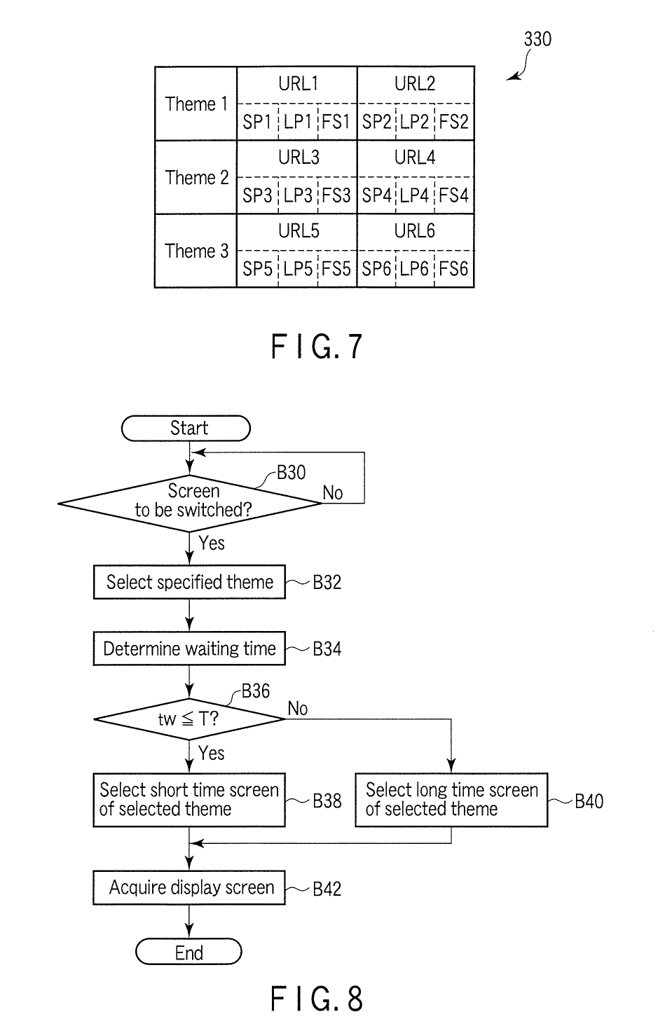

FIGS. 7 and 8 show a third embodiment. FIG. 7 is a diagram illustrating storage information in the screen storage 330 of the Web information display screen generator 133, and FIG. 8 is a flowchart showing the operation of screen selection.

The apparatus configuration in the third embodiment is similar to that in the first embodiment and also the basic operation is similar to that in the first embodiment. The third embodiment is different from the first embodiment in that a group of screens of a different type is preset for each theme and Web information of the theme specified in advance when switched by a remote controller operation is displayed.

The screen storage 330 of the Web information display screen generator 133 has, as shown in FIG. 7, the URL set for each theme and a short waiting time screen SP, a long waiting time screen LP, and a full screen FS stored for each of a plurality of Web sites (for example, two sites) for each theme. For theme 1, for example, a short waiting time screen SP1, a long waiting time screen LP1, and a full screen FS1 of URL 1 and a short waiting time screen SP2, a long waiting time screen LP2, and a full screen FS2 of URL 2 are stored. For theme 2, a short waiting time screen SP3, a long waiting time screen LP3, and a full screen FS3 of URL 3 and a short waiting time screen SP4, a long waiting time screen LP4, and a full screen FS4 of URL 4 are stored. For theme 3, a short waiting time screen SP5, a long waiting time screen LP5, and a full screen FS5 of URL 5 and a short waiting time screen SP6, a long waiting time screen LP6, and a full screen FS6 of URL 6 are stored.

If a switching operation of the screen to be displayed on the monitor 20 is performed by the remote controller 30 (YES in Block B30), for example, switched from TV viewing to Web browsing, as illustrated in the flowchart in FIG. 8, the one of themes specified in advance is selected (Block B32). The waiting time determination module 124 determines the waiting time tw necessary to switch the screen to one of the registered Web site (Block B34). Subsequently, the determined waiting time tw and the preset reference time T are compared (Block B36). If tw≦T, the Web information display screen controller 134 makes an inquiry about the short waiting time screen of the selected theme at the Web information display screen generator 133 (Block B38). If tw>T, the Web information display screen controller 134 makes an inquiry about the long waiting time screen of the selected theme at the Web information display screen generator 133 (Block B40). The Web information display screen generator 133 selects the screen in accordance with the inquiry and the waiting time screen is displayed in the monitor 20 by the Web side being selected by the switch 123 (Block B42).

As the selection method of theme, the theme may be selected in advance by being specified by the user. Alternatively, the theme related to the current TV viewing may automatically be selected. In this case, a keyword may be extracted from an electronic program guide (EPG) to select a theme close to the keyword. In addition, the theme may automatically be selected depending on the time zone. In early morning, for example, themes including today's weather forecast and train information may be selected.

Thus, according to the present embodiment, Web information of the theme specified in advance can be browsed during the waiting time of a TV operation. Therefore, the same effect as in the first embodiment can naturally be obtained and also more useful information can be provided to the user.

The present invention is not limited to the above embodiments. Switching of the operation is not limited to TV broadcasting to Web browsing and can be applied to switching of an operation requiring processing that takes a relatively long time such as TV broadcasting to data broadcasting, TV broadcasting to video recorder, and power-on.

When switching from TV broadcasting to data broadcasting, it takes time to receive data for one screen to create a video signal and it is effective to display information like in the present embodiment in the waiting time. When switching from TV viewing to recorder viewing, if, for example, the TV set and video recorder are connected by a video cable and the recorder is set to be turned on when video input is switched to the recorder in the TV set, it takes quite a long time before the recorder is started up even if the recorder is selected. It is effective to display information like in the embodiments in the waiting time. When a TV set is turned on, it may take time before the TV set is completely started up due to higher functionality of the TV set and in such a case, it is effective to display information like in the embodiments.

Content displayed in the waiting time is not necessarily limited to information about the Web site and may be information having video, descriptive text or the like. Content to be displayed may be information stored in a hard disk or the like in advance or information extracted from a network in real time. Information in RSS format may also be used.

The short waiting time screen information is not necessarily limited to the title and video and may be information containing an extremely small number of characters or a sentence. As the long waiting time screen information, information in RSS format may be used.

The present information is not necessarily limited to a TV set and can also be applied to various video display apparatuses capable of displaying video information. It is useful to apply the present invention particularly to an apparatus that requires processing accompanied by a waiting time to cause a display unit to display a desired screen.

The method described in the embodiments can be applied, as a computer program, to various apparatuses by storing to a storage medium such as a magnetic disk (floppy disk, hard disk and the like), optical disk (CD-ROM, DVD and the like), and semiconductor memory or to various apparatuses by transmitting via a communication medium. A computer that realizes the present invention may be any computer that reads a program recorded in a recording medium and whose operation is controlled by the program to perform the above processing.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A video display apparatus, comprising:
a display configured to display video information;
a display screen generator configured to generate first screen information for a short time and second screen information for a long time from a selected content;
a processing time calculation module configured to detect a presence or absence of a command specifying a process with a waiting time to display a desired screen on the display and to calculate a process time wt required for the process when the presence of the command is detected; and
a display screen controller configured to compare the process time wt with a reference time T, to select the first screen information when wt is not longer than T, to select the second screen information when wt is longer than T, and to display the selected screen information on the display during the waiting time first screen when the estimated waiting time.

2. (canceled)

3. (canceled)

4. The apparatus of claim 1, wherein the content comprises information of a Web site having a preset address and the display screen generator is configured to periodically access the Web site.

5. The apparatus of claim 4, wherein the first screen information comprises a title and representative image of the Web site and the second screen information comprises the title, the representative image, and a portion of a text of the Web site.

6. The apparatus of claim 1, wherein the display screen generator is configured to integrate information indicating progress of the process with the first screen information and the second screen information into a screen.

7. The apparatus of claim 1,
wherein the display screen generator is configured to generate plural first screen information and plural second screen information for plural contents, and
wherein the display screen controller is configured to simultaneously select plural first or second screen information and to integrate the selected plural first or second screen information into a screen.

8. The apparatus of claim 1,
wherein the display screen generator is configured to generate the first screen information and the second screen information for contents classified based on themes, and
wherein the display screen controller is configured to select the first or second screen information of a content corresponding to a selected theme.

9. The apparatus of claim 8, wherein the apparatus is configured to select a theme related to a program currently being viewed, a theme automatically determined based on time zone, or a theme specified by a user in order to select a theme.

10. A video display apparatus, comprising:
a television signal processor configured to generate a television information signal by receiving a television broadcast program;
a Web signal processor configured to generate a Web information signal by receiving Web information;
a switch configured to select one of the television information signal and the Web information signal; and
a display configured to display the signal selected by the switch, wherein the Web signal processor comprises:
a Web information display screen generator configured to generate first screen information for a short time and a second screen information for a long time by periodically accessing preset Web sites;
a detector configured to detect a remote controller operation to specify a process processing with a waiting time to display a desired screen on the display;
a processing time calculation module configured to calculate a process time wt required for the process when the detector detects the remote controller operation;
a Web information display screen controller configured to compare the process time wt with a predetermined waiting time T, to select the first screen information when wt is not longer than T, and to select the second screen information when wt is longer than T; and
a switching controller configured to set the switch to select screen information selected by the Web information display screen controller from detection of the remote controller operation until the process time wt elapses.

11. A video display method for displaying screen information corresponding to a specified command on a display of a video display apparatus, comprising:
generating first screen information for a short time and second screen information for a long time from a selected content;
detecting a presence or absence of a command specifying a process with a waiting time to display a desired screen on the display;
calculating a process time wt required for the process when the command is detected;
comparing the process time wt with a reference time T, selecting the first screen information when wt is not longer than T, and selecting the second screen information when wt is longer than T; and
displaying the select screen information on the display from detection of the command until the process time wt elapses.

12. (canceled)

13. (canceled)

14. The method of claim 11, wherein the content comprises information of a Web site having a preset address and the method comprising updating the information by periodically accessing the Web site.

15. The method of claim 14, wherein the first screen information comprises a title and representative image of the Web site and the second screen information comprises the title, the representative image, and a portion of a text of the Web site.

16. The method of claim 11, further comprising integrating information indicating progress of the process with the first screen information and the second screen information into a screen.

17. (canceled)

18. (canceled)

19. (canceled)

20. A non-transitory computer-readable storage medium storing computer-executable instructions that, when executed, cause a computer to:
generate first screen information for a short time and second screen information for a long time from a selected content;
detecting a presence or absence of a remote controller operation for specifying a process requiring switching a screen to be displayed on the display and having a waiting time to switch the screen;
calculating a process time wt required for the process when the a remote controller operation is detected;
comparing the process time wt with a reference time T, selecting the first screen information when wt is not longer than T, and selecting the second screen information when wt is longer than T; and
displaying the select screen information on the display from detection of the a remote controller operation until the process time wt elapses.

21. The apparatus of claim 1, wherein the apparatus detects a remote controller operation corresponding to the command in order to detect a presence or absence of the command.
